(19) United States
(12) Patent Application Publication
(10) Pub. No.: US 2002/0124412 A1
(43) Pub. Date: Sep. 12, 2002

(54) Utility knife tool with cover lock

(76) Inventor: Earl J. Votolato, Newport Beach, CA (US)

Correspondence Address: STETINA BRUNDA GARRED & BRUCKER, 75 Enterprise, Suite 250, Aliso Viejo, CA, 92656, US

(21) Appl. No.: 09/832,214

(22) Filed: Apr. 11, 2001

Related U.S. Application Data
(63) Continuation-in-part of application No. 09/804,451, filed on Mar. 12, 2001.

(51) Int. Cl. B26B 3/00

(52) U.S. Cl. 30/200

(57) ABSTRACT

A utility knife tool constructed to promote safety during use. The tool includes a handle with a distal portion, a blade secured to and extending from the distal portion, an integral, movable blade cover for enshrouding the blade when the tool is not in use and exposing the blade during use, and a blade-cover biasing member for urging the blade cover to a position covering the blade. A blade-cover locking system includes a cover-lock member with a first engagement element and hand-operable cover-release member with a second engagement element. In operation, the engagement elements are cooperatively engageable with each other whereby engagement of the elements with each other maintains the blade cover in a locked mode covering the blade and disengagement with each other releases the blade cover from the locked mode.

### CROSS-REFERENCE TO RELATED APPLICATIONS

This application is a continuation-in-part of copending U.S. patent application Ser. No. 009/804,451, entitled UTILITY KNIFE TOOL, filed Mar. 12, 2001.

### STATEMENT RE: FEDERALLY SPONSORED RESEARCH/DEVELOPMENT

(Not Applicable)

### BACKGROUND OF THE INVENTION

This invention relates in general to utility knives, and in particular to a utility knife tool having a blade cover and blade-cover locking system that maintains the blade cover in a locked configuration enshrouding a knife blade until a hand-operable, integral release mechanism is activated by a user.

Handheld utility knife tools typically have an extremely sharp blade protruding forward from a housing, and are routinely used by workers for opening boxes, cutting cardboard and other types of sheet material, cutting carpet, and like instances where a razor-sharp blade is required or advantageous. The housing generally functions as a substantially straight handle for the user to grip, and may include such features as finger contouring and a relatively large diameter to thereby attempt to provide an effective hand-comfortable design.

Because of the extremely sharp protruding blade, the presently available typical utility knife can be quite dangerous should a user accidentally come in contact with the blade. One manner in which the prior art has addressed such danger is to provide a friction-fit, non-attached cap for placement over the blade portion of the knife when the tool is not in use. When this cap is in place, the knife is safe to handle. Unfortunately, however, potential injury continues to exist during cap placement and removal procedures, as well as during unexpected blade travel while the knife is in use.

In view of the widespread use of utility knives coupled with the dangers as exemplified above, it is apparent that a need is present for a more safely operable and storable knife tool. Accordingly, a primary object of the present invention is to provide a utility knife tool having integral therewith a blade cover which is automatically deployed when the tool is not in use.

Another object of the present invention is to provide a utility knife tool wherein the blade cover is automatically locked in place when covering the blade and releasable only upon conscious input by an operator.

Yet another object of the present invention is to provide a utility knife tool wherein lock engagement elements of a blade-cover locking system cooperatively interact at each individual occurrence of blade exposure and prohibit blade-exposure maintenance.

These and other objects of the present invention will become apparent throughout the description thereof which now follows.

### BRIEF SUMMARY OF THE INVENTION

The present invention is a utility knife tool constructed to promote safety during use. The tool includes a handle with a distal portion, a blade secured to and extending from the distal portion, an integral, movable blade cover for enshrouding the blade when the tool is not in use and exposing the blade during use, and a blade-cover biasing member for urging the blade cover to a position covering the blade. A blade-cover locking system includes a cover-lock member with a first engagement element and hand-operable cover-release member with a second engagement element. In operation, the engagement elements are cooperatively engageable with each other whereby engagement of the elements with each other maintains the blade cover in a locked mode covering the blade and disengagement with each other releases the blade cover from the locked mode.

In a preferred embodiment, the cover-lock member is a wall of the blade cover, and the first engagement element is a notch disposed in this wall. The hand-operable cover-release member is an outwardly biased arm structure disposed along the handle for operator control, and the second engagement element is a distal end of the arm structure situated in the notch when the first and second engagement elements are engaged. When disengagement of the elements is required in order to use the knife tool, an operator simply moves the arm structure to dislodge the distal end thereof from the notch while simultaneously situating the blade of the knife tool on the item to be cut and applying sufficient pressure to cut the item. This application of pressure automatically pushes the blade cover upwardly to expose the cutting edge, while the cessation of pressure permits biasing action of the biasing member to force the blade cover to its earlier position covering the blade. Simultaneously, the two engagement elements re-engage and the blade cover once again is locked in place. Thus, after use, the knife tool can be carried, discarded, or otherwise handled while the blade thereof remains cover enshrouded.

### BRIEF DESCRIPTION OF THE DRAWINGS

An illustrative and presently preferred embodiment of the invention is shown in the accompanying drawings in which:

FIG. 1 is a perspective view of a utility knife tool with a blade cover thereof enshrouding the blade;

FIG. 2 is a perspective view of the tool of FIG. 1 with the blade thereof exposed;

FIG. 3 is a bottom plan view of the tool of FIG. 1.

### DETAILED DESCRIPTION OF THE INVENTION

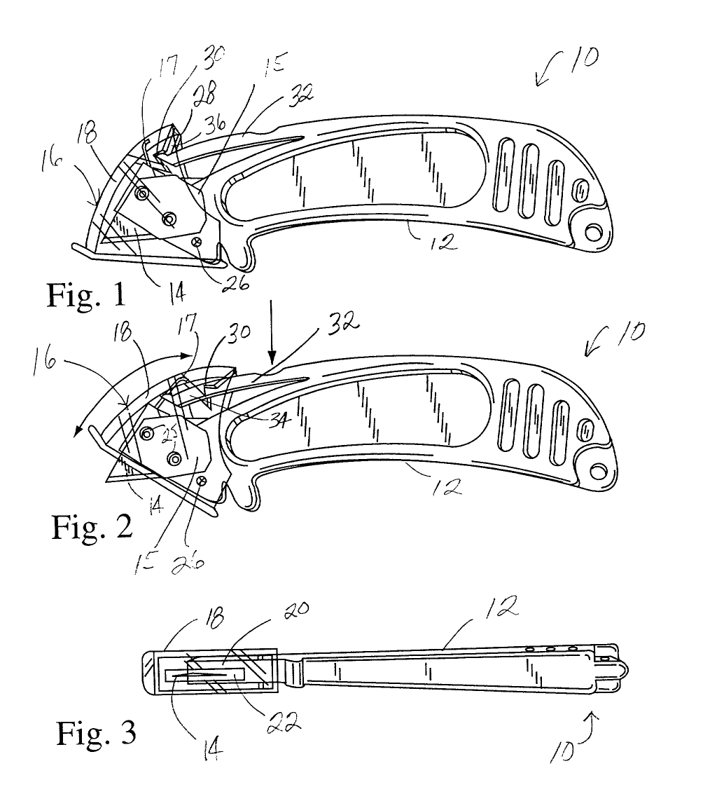

Referring to FIGS. 1 and 2, a utility knife tool 10 is illustrated. The tool 10 includes a plastic handle 12 with a metal blade 14 secured by rivets 25 to and extending from the distal portion 15 of the handle 12 and an integral, movable, blade cover 16 for enshrouding the bladel4 when the tool 10 is not in use and exposing the blade 14 during use. A conventional tension spring 17 urges the blade cover 16, which is preferably a transparent, arcuately-movable and arcuately-shaped plastic cap structure 18, to a position covering the blade 14 as shown in FIG. 1. As particularly shown in FIG. 3, the cap structure 18 has a floor 20 with a slot 22 there through to permit exposure of the blade 14 during use of the tool 10. The blade 14 is permanently held in place with conventional rivets 24, while the blade cover 14 is pivotally held in place by a rod 26 through the distal portion 15 of the handle 12. It is anticipated that the tool 10 is disposable and will be discarded once the blade 14 becomes inoperative.

A blade-cover locking system controls exposure of the blade 14. In particular, an inside peripheral wall 28 of the cap structure 18 functions as a cover-lock member and has a notch 30 disposed therein as a first engagement element. An outwardly-biased arm structure 32 disposed along the handle 12 functions as a hand-operable cover-release member and has a distal end 34 operating as a second engagement element and has access to the notch 30 through a rear opening 36 of the cap structure 18. When the notch 30 and distal end 34 are engaged with each other as shown in FIG. 1, the cap structure 18 is in a locked mode enshrouding the blade 14. Conversely, when the notch 30 and distal end 34 are not engaged with each other as shown in FIG. 2, the cap structure 18 is released from the locked mode and the cap structure 18 is permitted to be pivotally movable on the rod 26.

In operation, the tool 10 is handle-grasped by an operator and positioned on a substrate to be cut such that the blade 14 is seen through the transparent cap structure 18 to be in place over a site to be severed. The operator then presses the arm structure 32 toward the handle 12, thereby disengaging the notch 30 and a distal end 34 representing the first and second engagement elements, and thereafter applies pressure to the tool 10 which forces the blade 14 through the slot 22 and into the substrate as the cap structure 18 is pushed upwardly by said substrate to expose the blade 14 as it is exposed in FIG. 2. The operator moves the tool 10 along the path of cut until finished and then lifts the tool 10 from the substrate. Once this occurs, the spring 17 urges the cap structure 18 to the blade-enshrouding mode as shown in FIG. 1, which simultaneously re-engages the notch 30 and distal end 34 to once again lock the cap structure 18 in place. As is thus evident, the blade 14 of the tool 10 is exposed only during use, thereby providing an enhanced safety benefit for a person utilizing the instrument.

While an illustrative and presently preferred embodiment of the invention has been described in detail herein, it is to be understood that the inventive concepts may be otherwise variously embodied and employed and that the appended claims are intended to be construed to include such variations except insofar as limited by prior art.

1. A utility knife tool comprising:
a) a handle with a distal portion;
b) a blade secured to and extending from said distal portion;
c) an integral, movable blade cover for enshrouding the blade when the tool is not in use and exposing the blade during use;
d) a blade-cover biasing member for urging the blade cover to a position covering the blade; and
e) a blade-cover locking system comprising a cover-lock member with a first engagement element and hand-operable cover-release member with a second engagement element wherein the engagement elements are cooperatively engageable with each other whereby engagement of said elements with each other maintains the blade cover in a locked mode covering the blade and disengagement with each other releases the blade cover from said locked mode.

2. A utility knife as claimed in claim 1 wherein the blade cover generally enshrouds the blade as a cap structure over said blade.

3. A utility knife as claimed in claim 2 wherein the cap structure has a floor with a slot through which the blade is exposed.

4. A utility knife as claimed in claim 3 wherein the cap structure is arcuately movable and arcuately shaped.

5. A utility knife as claimed in claim 3 wherein the cap structure is substantially transparent.

6. A utility knife as claimed in claim 1 wherein the blade-cover biasing member is a tension spring.

7. A utility knife as claimed in claim 1 wherein the cover-lock member is a wall of the blade cover and the first engagement element is a notch disposed in said wall, and wherein the hand-operable cover-release member is an outwardly biased arm structure disposed along the handle and the second engagement element is a distal end of the arm structure situated in the notch when the first and second engagement elements are engaged.

8. A utility knife as claimed in claim 7 wherein the blade cover is generally arcuately movable and arcuately shaped and wherein the wall of the blade cover is an inside peripheral wall accessible by the arm structure through a rear opening into the blade cover.
